(19) United States
(12) Patent Application Publication
(10) Pub. No.: US 2022/0002616 A1
(43) Pub. Date: Jan. 6, 2022

(54) POLYMER-BASED PROPPANT FOR UNCONVENTIONAL COMPLETIONS

(71) Applicant: ExxonMobil Upstream Research Company, Spring, TX (US)

(72) Inventors: KAUSTUBH S. KULKARNI, SPRING, TX (US); DOUGLAS A. MITCHELL, TOMBALL, TX (US); TIMOTHY J. NEDWED, HOUSTON, TX (US); WILLIAM R. MEEKS, MIDLAND, TX (US); DARYL ALLEN, PASADENA, CA (US)

(21) Appl. No.: 17/221,871

(22) Filed: Apr. 5, 2021

Related U.S. Application Data
(60) Provisional application No. 63/046,878, filed on Jul. 1, 2020.

(51) Int. Cl. C09K 8/80; C09K 8/62; C08G 61/02

(52) U.S. Cl. CPC C09K 8/80; C08G 61/02; C09K 8/62

(57) ABSTRACT

A method of forming polymeric proppants in-situ during a fracturing operation. The method includes the steps of delivering reagents downhole and combining the reagents in a first mixing chamber to initiate polymerization; atomizing the combined reagents by passing them through an atomizer as they exit the first mixing chamber to form partially polymerized polymeric bodies; pumping water down a production casing; mixing the partially polymerized polymeric bodies and the water in a second mixing chamber; completing polymerization and forming solid polymeric proppants upon exiting the second mixing chamber; and passing the solid polymeric proppants through perforations in the casing and into fractures within the formation. A system for forming polymeric proppants in-situ during a fracturing operation and a method for forming solid polymeric proppants at the surface of a formation for use in a fracturing operation is also provided.

### CROSS-REFERENCE TO RELATED APPLICATIONS

This application claims the benefit of U.S. Provisional Application 63/046,878, filed Jul. 1, 2020, the disclosure of which is hereby incorporated by reference in its entirety.

### FIELD OF THE INVENTION

The present disclosure relates to the treatment of subterranean, hydrocarbon bearing formations. In particular, the present disclosure relates to systems and methods for forming polymer-based proppants.

### BACKGROUND OF THE INVENTION

In the completion and operation of oil wells, gas wells and similar boreholes, it is often desirable to alter the producing characteristics of the formation by treating the well. Many such treatments involve the use of particulate material. For example, in hydraulic fracturing, propping agents may be used to maintain the fracture in a propped condition.

Hydraulic fracturing is one of the most complex oilfield services employed today, requiring equipment to transport and store water and chemicals, prepare the fracturing fluid, blend the fluid with proppant, pump the fluid down the well and monitor the treatment.

Hydraulic fracturing is a stimulation technique used to create a fracture network in a reservoir to provide a highly permeable pathway for production fluids and gas moving from the reservoir into a wellbore. The fracture network is created by applying pressure on the formation to split the rock and pumping a mixture of fracturing fluid and proppant into it.

Although particulate material is used in the treatment of formations for a variety of reasons, there is one problem common to most such treatments the problem of particle strength and stability. In hydraulic fracturing, propping agent particles under high closure stress tend to fragment and disintegrate. Silica sand, historically, the most common proppant, is normally not employed at closure stresses above about 5000 psi due to its propensity to disintegrate. The resulting fines from this disintegration migrate and plug interstitial flow passages in the propped interval.

In certain instances, the use of propping agents other than sand has resulted in improved well productivity. Organic materials, such as the shells of walnuts, coconuts, and pecans, have been used. These organic materials are deformed rather than crushed when the fracture attempts to close under the overburden load.

Another type of propping agent which deforms rather than fails under loading is aluminum. Generally, the fracture flow capacity obtained with aluminum pellets is about one-third higher than obtainable with rounded walnut shells of corresponding particle size. However, the fractures obtained using these deformable proppants is not always satisfactory. Due to the deformation of such particles, the propped fracture width is considerably smaller than the original proppant diameter. In addition, as these particles are squeezed flatter and flatter the space between the particles grows smaller further reducing flow capacity.

Resin-coated particles have also been used in efforts to improve stability of proppants at high closure stresses. Sand or other substrates have been coated with an infusible resin such as epoxy. However, at high temperature and high stress levels, resin-coated particles have shown a decrease in permeability to about the same degree as silica sand.

In unconventional well completions, sand or proppant is pumped down a production casing using water as a carrier fluid at high rates. The high pressure is used to fracture the well at pre-perforated locations and proppant is injected in the fractures to provide high permeability pathways for oil and gas. In addition to proppant stability, the sheer volume of sand required can be a problem. According to some estimates, five hundred trucks of sand may be required per well. This large sand volume requirement can be a significant logistics challenge.

Therefore, what is needed is a stable, high-strength proppant that reduces the net requirement of proppant volume using a high strength polymer proppant that can be created in-situ from liquid reagents during the fracturing process.

### SUMMARY OF THE INVENTION

In one aspect, provided is a method of forming polymeric proppants in-situ during a fracturing operation. The method includes the steps of delivering reagents downhole and combining the reagents in a first mixing chamber to initiate polymerization; atomizing the combined reagents by passing them through an atomizer as they exit the first mixing chamber to form partially polymerized polymeric bodies; pumping water down a production casing; mixing the partially polymerized polymeric bodies and the water in a second mixing chamber; completing polymerization and forming solid polymeric proppants upon exiting the second mixing chamber; and passing the solid polymeric proppants through perforations in the casing and into fractures within the formation.

In some embodiments, the reagents comprise a monomer and a catalyst. In some embodiments, the monomer comprises dicyclopentadiene and functionalized norbornene. In some embodiments, the catalyst is a Grubbs catalyst. In some embodiments, the combined reagents undergo rapid cross-linking polymerization to form the solid polymeric proppants.

In some embodiments, the solid polymeric proppants have a compressive strength of greater than 15 ksi. In some embodiments, the solid polymeric proppants are hydrophobic. In some embodiments, the solid polymeric proppants are formed as substantially spherical beads.

In some embodiments, the reagents are delivered through a conduit positioned within the production casing. In some embodiments, the conduit comprises a coiled tubing. In some embodiments, the conduit comprises a dual chamber conduit having a first chamber for pumping the monomer downhole and a second chamber for pumping the catalyst downhole. In some embodiments, the conduit is coiled tubing sub that contains the reagents in predetermined amounts for mixing downhole to initiate polymerization.

In some embodiments, the ratio of monomer to catalyst is greater than about 25:1. In some embodiments, the ratio of monomer to catalyst is about 50:1.

In some embodiments, one of the reagents comprises a siloxane. In some embodiments, the siloxane comprises MeO— groups and/or EtO— groups.

In some embodiments, the solid polymeric proppants formed in-situ possess sufficient size and compressive strength for the fracturing operation.

In another aspect, provided is a system for forming polymeric proppants for use during a fracturing operation within a formation. The system includes a first mixing chamber having a downstream end, for combining the reagents to initiate polymerization; an atomizer positioned adjacent the downstream end of the first mixing chamber for forming partially polymerized polymeric bodies; and a second mixing chamber positioned downstream of the atomizer for mixing the partially polymerized polymeric bodies and water pumped down the production casing to complete polymerization and form solid polymeric proppants.

In some embodiments, the reagents comprise a monomer and a catalyst. In some embodiments, the monomer comprises dicyclopentadiene and functionalized norbornene. In some embodiments, the catalyst is a Grubbs catalyst. In some embodiments, the combined reagents undergo rapid cross-linking polymerization to form the solid polymeric proppants.

In some embodiments, the solid polymeric proppants have a compressive strength of greater than 15 ksi. In some embodiments, the solid polymeric proppants are hydrophobic. In some embodiments, the solid polymeric proppants are formed as substantially spherical beads.

In some embodiments, the system is positioned within a production casing and also includes a conduit positioned within the production casing, wherein the reagents are delivered downhole through the conduit. In some embodiments, the conduit comprises a coiled tubing. In some embodiments, the conduit comprises a dual chamber conduit having a first chamber for pumping the monomer downhole and a second chamber for pumping the catalyst downhole. In some embodiments, the conduit is coiled tubing sub that contains the reagents in predetermined amounts for mixing downhole to initiate polymerization.

In some embodiments, the ratio of monomer to catalyst is greater than about 25:1. In some embodiments, the ratio of monomer to catalyst is about 50:1.

In some embodiments, one of the reagents comprises a siloxane. In some embodiments, the siloxane may be comprised of MeO— groups and/or EtO— groups.

In some embodiments, the solid polymeric proppants formed in-situ possess sufficient size and compressive strength for the fracturing operation.

In yet another aspect, provided is a method of forming solid polymeric proppants at the surface of a formation for use in a fracturing operation within the formation. The method includes the steps of: combining reagents in a first mixing chamber; atomizing the combined reagents by passing them through an atomizer as they exit the first mixing chamber to form partially polymerized polymeric bodies; mixing the partially polymerized polymeric bodies and water in a second mixing chamber; completing polymerization and forming solid polymeric proppants upon exiting the second mixing chamber; pumping the solid polymeric proppants and water down a casing; and passing the solid polymeric proppants through perforations in the casing and into fractures formed within the formation.

In some embodiments, the reagents comprise a monomer and a catalyst. In some embodiments, the monomer comprises dicyclopentadiene and functionalized norbornene. In some embodiments, the catalyst is a Grubbs catalyst. In some embodiments, the combined reagents undergo rapid cross-linking polymerization to form the solid polymeric proppants.

In some embodiments, the solid polymeric proppants have a compressive strength of greater than 15 ksi. In some embodiments, the solid polymeric proppants are hydrophobic.

In some embodiments, the ratio of monomer to catalyst is greater than about 25:1. In some embodiments, the ratio of monomer to catalyst is about 50:1.

In some embodiments, one of the reagents comprises a siloxane. In some embodiments, the siloxane may be comprised of MeO— groups and/or EtO— groups.

### BRIEF DESCRIPTION OF THE DRAWINGS

FIG. 1 presents a schematic view of an illustrative example of a system for forming polymeric proppants, in situ, during a fracturing operation within a formation, according to a first form of the present disclosure.

FIG. 2 presents a schematic view of an illustrative, non-exclusive example, of an atomizer for forming partially polymerized polymeric bodies, according to the present disclosure.

FIG. 3 presents a schematic view of an illustrative, non-exclusive example of a system for hydraulic fracturing, according to one form of the present disclosure.

FIG. 4 presents a schematic view of an illustrative example of a system for forming polymeric proppants during a fracturing operation, according to another form of the present disclosure.

FIG. 5 presents a schematic view of an illustrative, non-exclusive example of a system for hydraulic fracturing, according to another form of the present disclosure.

FIG. 6 provides an exemplary representation of a polymerization reaction according to the present disclosure.

FIGS. 7 and 8 provide plots of compressive testing showing the strength of one polymeric proppant, according to the present disclosure.

### DETAILED DESCRIPTION OF THE INVENTION

FIGS. 1-8 provide illustrative, non-exclusive examples of methods and systems for forming polymeric proppants during a fracturing operation within a formation, methods and systems, according to the present disclosure and/or of systems, apparatus, and/or assemblies that may include, be associated with, be operatively attached to, and/or utilize such systems. In FIGS. 1-8, like numerals denote like, or similar, structures and/or features; and each of the illustrated structures and/or features may not be discussed in detail herein with reference to each of FIGS. 1-8. Similarly, each structure and/or feature may not be explicitly labeled in each of FIGS. 1-8; and any structure and/or feature that is discussed herein with reference to any one of FIGS. 1-8 may be utilized with any other of FIGS. 1-8 without departing from the scope of the present disclosure.

In general, structures and/or features that are, or are likely to be, included in a given embodiment are indicated in solid lines in FIGS. 1-8, while optional structures and/or features are indicated in broken lines. However, a given embodiment is not required to include all structures and/or features that are illustrated in solid lines therein, and any suitable number of such structures and/or features may be omitted from a given embodiment without departing from the scope of the present disclosure.

FIG. 1 presents a schematic view of an illustrative example of a system for forming polymeric proppants 10. As will be discussed in more detail, the proppants may be formed, in situ, during a fracturing operation within a formation F. System 10 includes a first mixing chamber 12 having a downstream end 14, for combining the reagents to initiate polymerization. System 10 also includes an atomizer 16 positioned adjacent the downstream end 14 of the first mixing chamber 12 for forming partially polymerized polymeric bodies B; and a second mixing chamber 18 positioned downstream of the atomizer 16 for mixing the partially polymerized polymeric bodies B and water W pumped down the production casing 20 to complete polymerization and form solid polymeric proppants P. The water W enters the second mixing chamber 18 through a plurality of perforations 36, which may be positioned about the outer surface 38 of the second mixing chamber 18. When positioned downhole to form proppants, in situ, system 10 may be positioned adjacent a stage plug 40, so that the polymeric proppants exit the casing 20 through perforations 42.

As will be discussed in more detail below, in some embodiments, the reagents comprise a monomer and a catalyst. In some embodiments, the monomer comprises dicyclopentadiene and functionalized norbornene. In some embodiments, the catalyst is a Grubbs catalyst. The combined reagents undergo rapid cross-linking polymerization to form the solid polymeric proppants P.

In accordance herewith, the solid polymeric proppants P formed in-situ possess sufficient size and compressive strength for the fracturing operation. The solid polymeric proppants may have a compressive strength of greater than 15 ksi. In some embodiments, the solid polymeric proppants are hydrophobic. The solid polymeric proppants may be formed as substantially spherical beads.

As shown in FIG.1, the system 10 may be positioned within a production casing 20. A conduit 22 may be positioned within the production casing 20 for the delivery of the reagents downhole through the conduit 22. In some embodiments, the conduit comprises a coiled tubing 24. The conduit 22 may comprise a dual chamber conduit 26 having a first chamber 28, for pumping the monomer downhole, and a second chamber 30, for pumping the catalyst downhole.

Alternatively, the conduit may be coiled tubing sub (not shown) that contains the reagents in predetermined amounts for mixing downhole to initiate polymerization.

The ratio of monomer to catalyst may be greater than about 25:1. In some embodiments, the ratio of monomer to catalyst is about 50:1.

As will be described in more detail below, alternatively, one of the reagents may comprise a siloxane. In some embodiments, the siloxane may be comprised of MeO— groups and/or EtO— groups.

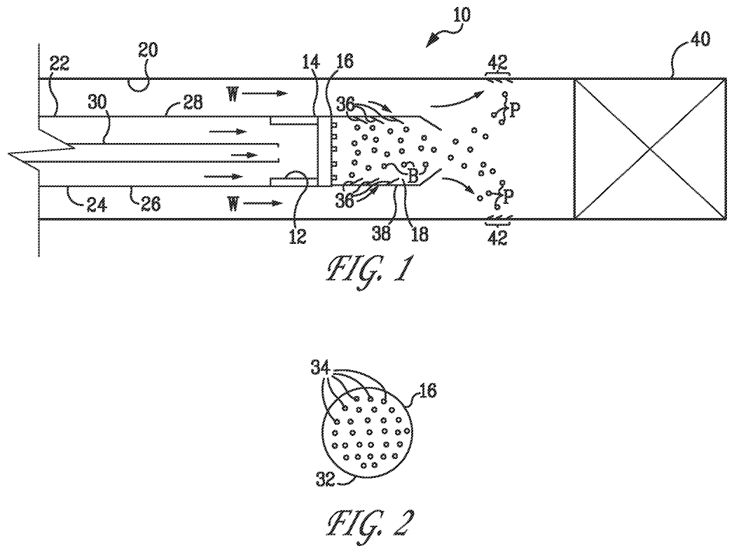

Referring now to FIG. 2, a schematic view of an illustrative, non-exclusive example, of an atomizer (nozzle) 16 for forming partially polymerized polymeric bodies B, according to the present disclosure, is shown. Atomizer 16 may be in the form of a cylindrical plate 32, as shown, though other configurations are contemplated, as those skilled in the art will plainly understand. Atomizer 16 is provided with a plurality of openings 34 for forming the partially polymerized polymeric bodies B as they exit the openings 34. The openings may be positioned in a uniform or non-uniform manner, the design of which is within the skill of one of ordinary skill in the art. Likewise, the sizing of the openings 34 may be designed to produce partially polymerized polymeric bodies B of an appropriate size and a spherical shape.

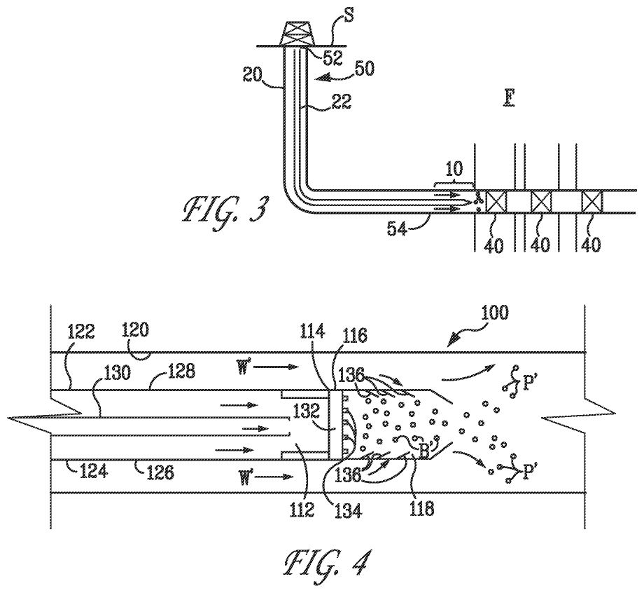

Referring now to FIG. 3, a schematic view of an illustrative, non-exclusive example of a system for hydraulic fracturing 50, according to one form of the present disclosure, is shown. As those skilled in the art will understand, fracturing system 50 may include a plurality of water tanks, each typically in the form of a conventional portable tank and other tanks for thickening the water, as desired (not shown), at surface S. Manifolding and appropriate piping may also be employed as needed, as those skilled in the art will understand. Appropriate pumps (not shown) are also provided.

Casing 20 may initiate at the surface S and extend downwardly into the formation F and have one or more stage plugs 40 positioned downstream, to isolate various production zones. Conduit 22 has a first end 52 that terminates at or near the surface S, and a second end 54 that terminates downstream at the system for forming polymeric proppants 10, described in detail with respect to FIGS. 1 and 2.

FIG. 4 presents a schematic view of an illustrative example of a system for forming polymeric proppants operation 100, according to another form of the present disclosure. In this embodiment, the polymeric proppants may be fully formed at the surface and pumped downhole with fracturing water.

System 100 includes a first mixing chamber 112 having a downstream end 114, for combining the reagents to initiate polymerization. System 100 also includes an atomizer 116 positioned adjacent the downstream end 114 of the first mixing chamber 112 for forming partially polymerized polymeric bodies B′; and a second mixing chamber 118 positioned downstream of the atomizer 116 for mixing the partially polymerized polymeric bodies B′ and water W′ pumped down the tubular 120 to complete polymerization and form solid polymeric proppants P. The water W′ enters the second mixing chamber 118 through a plurality of perforations 136, which may be positioned about the outer surface 138 of the second mixing chamber 118.

As will be discussed in more detail below, in some embodiments, the reagents comprise a monomer and a catalyst. In some embodiments, the monomer comprises dicyclopentadiene and functionalized norbornene. In some embodiments, the catalyst is a Grubbs catalyst. The combined reagents undergo rapid cross-linking polymerization to form the solid polymeric proppants P.

In accordance herewith, the solid polymeric proppants P formed at the surface possess sufficient size and compressive strength for the fracturing operation. The solid polymeric proppants may have a compressive strength of greater than 15 ksi and may be hydrophobic. The solid polymeric proppants may be formed as substantially spherical beads.

As shown in FIG. 4, the system 100 may be positioned within a tubular 120. The downstream end of tubular 120 may be placed in fluid communication with a production casing (not shown). A conduit 122 may be positioned within the tubular 120 for the delivery of the reagents downhole through the conduit 122. In some embodiments, the conduit is formed from a section of coiled tubing 124. The conduit 122 may comprise a dual chamber conduit 126 having a first chamber 128, for pumping the monomer downhole, and a second chamber 130, for pumping the catalyst therethrough.

Still referring to FIG. 4, atomizer (nozzle) 116 may be in the form of a cylindrical plate 132, (see FIG. 2 for this detail), though other configurations are contemplated. Atomizer 116 is provided with a plurality of openings 134 for forming the partially polymerized polymeric bodies B′ as they exit the openings 134. The openings may be positioned in a uniform or non-uniform manner, the design of which is within the skill of one of ordinary skill in the art. Likewise, the sizing of the openings 134 may be designed to produce partially polymerized polymeric bodies B′ of an appropriate size and a spherical shape.

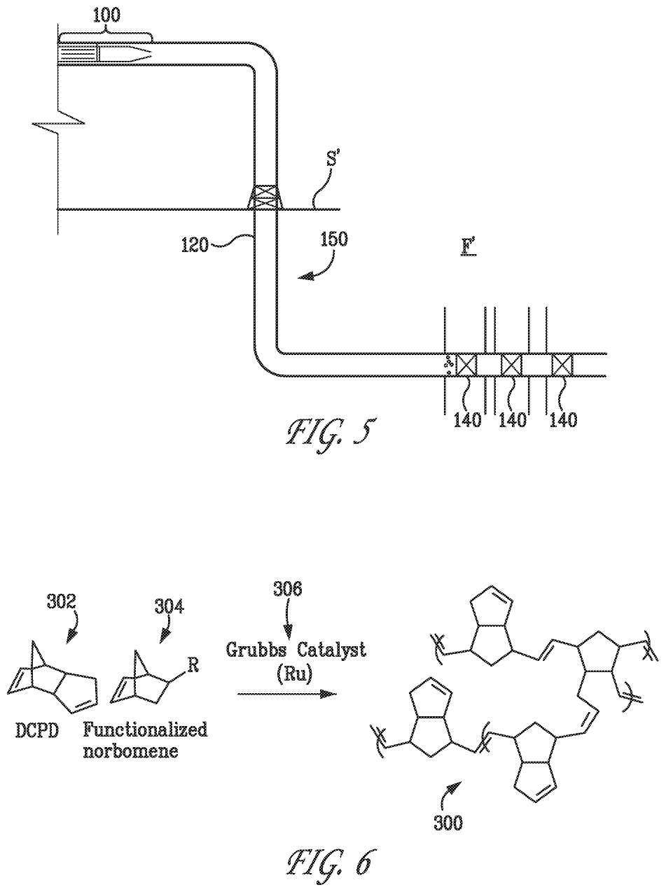

Referring now to FIG. 5, a schematic view of an illustrative, non-exclusive example of a system for hydraulic fracturing 150, according to one form of the present disclosure, is shown. As those skilled in the art will understand, fracturing system 150 may include a plurality of water tanks, each typically in the form of a conventional portable tank and other tanks for thickening the water, as desired (not shown), at surface S′. Manifolding and appropriate piping may also be employed as needed, as those skilled in the art will understand. Appropriate pumps (not shown) are also provided.

Casing 120 may initiate at the surface S′ and extend downwardly into the formation F′ and have one or more stage plugs 140 positioned downstream, to isolate various production zones. Casing 120 may also extend above S′ and terminate upwards at the system for forming polymeric proppants 100, described in detail with respect to FIG. 4.

Suitable polymer systems include those using liquid monomers such as dicyclopentadiene (DCPD) and/or functionalized norborene, and a Grubbs Catalyst (Ru) to create a polymer proppant at a desired or controlled cure rate, resulting in a solid or rigid proppant. Grubbs' Ru-based ring opening metathesis (ROM) and Grubbs Ru-based Ring-opening metathesis polymerization (ROMP) processes are exemplary polymerization processes according to the presently disclosed technology.

In many applications, the activated and crosslinked polymer is formed in situ by combining suitable polymerizable liquid monomers (such as dicyclopentadiene (DCPD) or norborene) with a liquid Grubbs catalyst (Nguyen et al. 2000; Grubbs 2006)) at or near the location of use.

The ring opening metathesis polymerization (ROMP) or ring opening metathesis reactions of the DCPD and/or functionalized norborene, with the Grubbs catalyst are illustrated in exemplary FIG. 6. Proppant forming agent monomers or polymers, such as DCPD 302 and/or norborene 304 are activated into a polymerization reaction with the Grubbs Catalyst 306 to form the polymer proppant 300. These exothermic polymerization reactions are highly adjustable depending on the functional groups attached to the monomer and catalyst (Bielawski & Grubbs 2007). Cure times may be adjusted in a range of from seconds to hours depending on the application. The proppant-forming agents and the catalysts may be combined at a wide range of ratios, such as at a ratio of between 25:1 and 50:1, or between 25:1 and 100:1, or between 20:1 and 200:1, and generally exhibit relatively low viscosity liquids (about the viscosity of water) when first combined (unless of course, the reaction is designed to happen at an accelerated rate), even at low temperatures such as may be encountered subsea. The reaction time may be adjusted such that the combined polymer and catalyst may be formed at the rate desired.

In addition to altering the polymer-to-catalyst ratio to affect the reaction rate, the reaction initiation rate also may be altered by replacing certain ligands with more labile or reactive ligands, such as replacing the phosphine ligand with pyridine ligands. The reacting or cross-linking of the polymer results in a solid material that bonds well to metal and exhibits toughness properties and resistance to shear properties that may be desirable in applications related to use in wellbores and/or subsurface formations.

The presently disclosed technology also includes a method for forming polymeric proppants in-situ during a fracturing operation. The method includes the steps of delivering reagents downhole and combining the reagents in a first mixing chamber to initiate polymerization; atomizing the combined reagents by passing them through an atomizer as they exit the first mixing chamber to form partially polymerized polymeric bodies; pumping water down a production casing; mixing the partially polymerized polymeric bodies and the water in a second mixing chamber; completing polymerization and forming solid polymeric proppants upon exiting the second mixing chamber; and passing the solid polymeric proppants through perforations in the casing and into fractures within the formation.

In some embodiments, the reagents comprise a monomer and a catalyst. In some embodiments, the monomer comprises dicyclopentadiene and functionalized norbornene. In some embodiments, the catalyst is a Grubbs catalyst. In some embodiments, the combined reagents undergo rapid cross-linking polymerization to form the solid polymeric proppants.

As may be appreciated, proper hydraulic fracture treatment design requires knowledge of in-situ stress, geology, and the geologic structure creating the stress. Stress is defined as force/area. A comparison of trendlines for the U.S. Gulf Coast, the North Sea and the Netherlands (onshore), suggests that the horizontal stress at about 3,500 ft. is about 2.5 ksi. At about 5,000 ft., it is about 4.0 ksi, at about 7,500 ft., it is about 6.5 ksi, at about 10,000 ft., it is about 8.8 ksi and at 15,000 ft., it is about 10 ksi. Estimates suggest that at about 20,000 ft., the horizontal stress may be upwards of 15 ksi, or more. (See: Breckels, I. M., Relationship between horizontal stress and depth in sedimentary basins, Presented at 1981 Annual Meeting of SPE, San Antonio, Tex., SPE 10336.)

In some embodiments, the solid polymeric proppants have a compressive strength of greater than 15 ksi. This level of strength suggests the ability to withstand depths of up to about 20,000 ft. As such, the solid polymeric proppants disclosed herein have utility over a compressive strength range of about 4 ksi to about 15 ksi, for depths of about 5,000 to about 20,000 ft., or from about 6.5 ksi to about 15 ksi, for depths of about 7,500 to about 20,000 ft., or from about 8.8 ksi to about 15 ksi, for depths of about 10,000 to about 20,000 ft., or from 10 ksi to about 15 ksi, for depths of about 15,000 to about 20,000 ft.

In some embodiments, the solid polymeric proppants are hydrophobic. In some embodiments, the solid polymeric proppants are formed as substantially spherical beads.

In some embodiments, the reagents are delivered through a conduit positioned within the production casing. In some embodiments, the conduit comprises a coiled tubing. In some embodiments, the conduit comprises a dual chamber conduit having a first chamber for pumping the monomer downhole and a second chamber for pumping the catalyst downhole. In some embodiments, the conduit is coiled tubing sub that contains the reagents in predetermined amounts for mixing downhole to initiate polymerization. In some embodiments, the ratio of monomer to catalyst is greater than about 25:1. In some embodiments, the ratio of monomer to catalyst is about 50:1.

In some embodiments, one of the reagents comprises a siloxane. In some embodiments, the siloxane comprises MeO— groups and/or EtO— groups.

In some embodiments, the solid polymeric proppants formed in-situ possess sufficient size and compressive strength for the fracturing operation.

The presently disclosed technology also includes a method of forming solid polymeric proppants at the surface of a formation for use in a fracturing operation within the formation. The method includes the steps of: combining reagents in a first mixing chamber; atomizing the combined reagents by passing them through an atomizer as they exit the first mixing chamber to form partially polymerized polymeric bodies; mixing the partially polymerized polymeric bodies and water in a second mixing chamber; completing polymerization and forming solid polymeric proppants upon exiting the second mixing chamber; pumping the solid polymeric proppants and water down a casing; and passing the solid polymeric proppants through perforations in the casing and into fractures formed within the formation.

In some embodiments, the reagents comprise a monomer and a catalyst. In some embodiments, the monomer comprises dicyclopentadiene and functionalized norbornene. In some embodiments, the catalyst is a Grubbs catalyst. In some embodiments, the combined reagents undergo rapid cross-linking polymerization to form the solid polymeric proppants.

In some embodiments, the solid polymeric proppants have a compressive strength of greater than 15 ksi. In some embodiments, the solid polymeric proppants are hydrophobic.

In some embodiments, the ratio of monomer to catalyst is greater than about 25:1. In some embodiments, the ratio of monomer to catalyst is about 50:1.

In some embodiments, one of the reagents comprises a siloxane. In some embodiments, the siloxane may be comprised of MeO— groups and/or EtO— groups.

Many variations of Grubbs' catalysts may be utilized for the initiators for the proppant-forming operations as disclosed herewith, but the ring-opening metathesis (ROM) and especially ring-opening metathesis polymerization (ROMP) are of particular interest.

The proppant-forming agent may comprise a liquid monomer, such as dicyclopentadiene or norborene, utilizing a polymerization reaction initiating catalyst, such as but not limited to Grubbs' Ru-based (Ruthenium-based) ring opening metathesis polymerization (ROMP) catalyst to crosslink the liquid monomer. The Grubbs Ru catalysts may include any of the first, second, and third generation catalysts, depending upon the desire reaction rate and conditions. The proppant-forming agent may comprise a siloxane, and the siloxane may comprise, for example, alkoxy groups, which may include, for example at least one of methoxy groups and ethoxy groups. The siloxane may crosslink in the presence of water for some applications or may be designed to crosslink in the presence of a catalyst such as the Grubb's Ru-base catalyst. As discussed previously, the term “crosslinking” as used herein may include polymerization, chemical bonding, and traditional polymer strand physical intermeshing.

### EXAMPLE

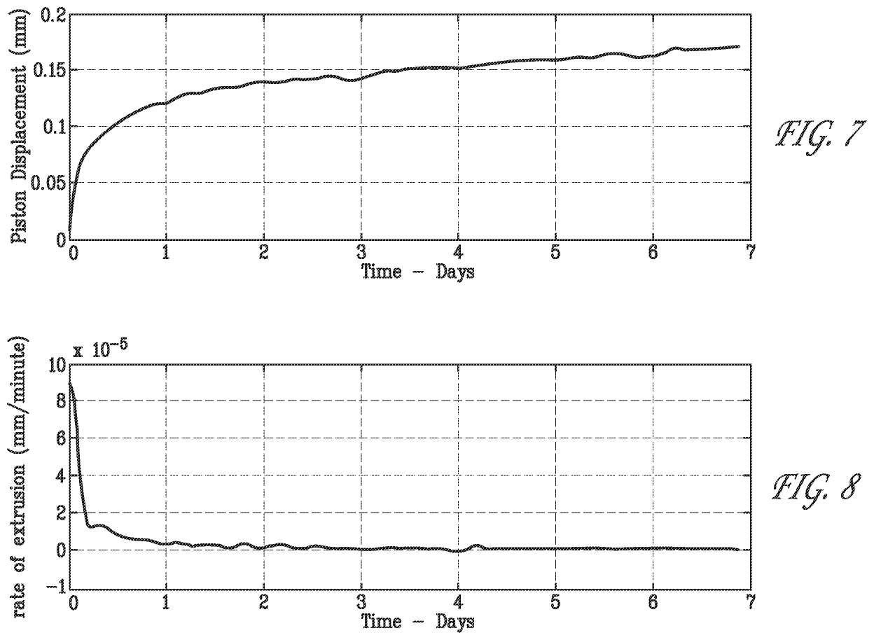

The compressive strength (i.e. proppant crush strength) of the solid polymer was tested in an uni-axial setup (MTS) at 15000 psi equivalent for more than seven days and found to show very low (<1%) deformation. This is indicative of significantly high compressive strength, as shown in FIGS. 7 and 8. In some embodiments, the solid polymeric proppants have a compressive strength of greater than 15 ksi.

It should be noted that the actual crush strength may be higher. Competitive synthetic proppants have been shown to possess 10-12 ksi compressive strength.

The hydrophobic nature of the polymers is known from the chemistry attributes and was observed during tests conducted as part of an Advanced Well Control research program at SwRI.

As may be appreciated, this disclosure addresses the no-sand stimulation challenge through the following primary advantages: 1) the constituent reagents, namely monomer and catalyst are low viscosity liquids (˜1 cP for >70 F) that can be pumped down a coil tubing (or equivalent) during a slick-water fracture operation at a much lower pressure than conventional sand slurries; 2) the lower pressures may help extend the lateral length for a given casing (burst pressure rating); and 3) the polymerization reaction is very rapid (<10 seconds at 150+F.), typical downhole conditions for typical fracturing environments, and can supply the necessary volume of proppants under in-situ conditions for the necessary flow rates.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

Illustrative, non-exclusive examples of systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

PCT1. A method of forming polymeric proppants in-situ during a fracturing operation within a formation, comprising the steps of: delivering reagents downhole and combining the reagents in a first mixing chamber to initiate polymerization; atomizing the combined reagents by passing them through an atomizer as they exit the first mixing chamber to form partially polymerized polymeric bodies; pumping water down a production casing; mixing the partially polymerized polymeric bodies and the water in a second mixing chamber; completing polymerization and forming solid polymeric proppants upon exiting the second mixing chamber; and passing the solid polymeric proppants through perforations in the casing and into fractures within the formation.

PCT2. The method of paragraph PCT1, wherein the reagents comprise a monomer and a catalyst.

PCT3. The method of paragraph PCT2, wherein the monomer comprises dicyclopentadiene and functionalized norbornene and the catalyst is a Grubbs catalyst.

PCT4. The method of paragraphs PCT1-PCT3, wherein the combined reagents undergo rapid cross-linking polymerization to form the solid polymeric proppants.

PCT5. The method of any of paragraphs PCT1-PCT4, wherein the solid polymeric proppants have a compressive strength of greater than 15 ksi.

PCT6. The method of any of paragraphs PCT1-PCT5, wherein the solid polymeric proppants are hydrophobic.

PCT7. The method of any of paragraphs PCT1-PCT6, wherein the solid polymeric proppants are formed as substantially spherical beads.

PCT8. The method of any of paragraphs PCT1-PCT7, wherein the reagents are delivered downhole through a conduit positioned within the production casing.

PCT9. The method of paragraph PCT8, wherein the conduit comprises a coiled tubing.

PCT10. The method of paragraph PCT9, wherein the conduit comprises a dual chamber conduit having a first chamber for pumping the monomer downhole and a second chamber for pumping the catalyst downhole.

PCT11. The method of paragraph PCT9, wherein the conduit is coiled tubing sub that contains the reagents in predetermined amounts for mixing downhole to initiate polymerization.

PCT12. The method of any of paragraphs PCT2-PCT11, wherein the ratio of monomer to catalyst is greater than about 25:1.

PCT13. The method of any of paragraphs PCT2-PCT12, wherein the ratio of monomer to catalyst is about 50:1.

PCT14. The method of claim PCT2, wherein one of the reagents comprises a siloxane.

PCT15. The method of paragraph PCT14, wherein the siloxane comprises MeO— groups and/or EtO— groups.

PCT16. The method of paragraphs PCT1-PCT15, wherein the solid polymeric proppants formed in-situ possess sufficient size and compressive strength for the fracturing operation.

PCT17. A system for forming polymeric proppants for use during a fracturing operation within a formation, the system comprising: a first mixing chamber having a downstream end, for combining the reagents to initiate polymerization; an atomizer positioned adjacent the downstream end of the first mixing chamber for forming partially polymerized polymeric bodies; and a second mixing chamber positioned downstream of the atomizer for mixing the partially polymerized polymeric bodies and water pumped down the production casing to complete polymerization and form solid polymeric proppants.

PCT18. The system of paragraph PCT17, wherein the system is positioned within a production casing, further comprising a conduit positioned within the production casing, wherein the reagents are delivered downhole through the conduit.

PCT19. The system of paragraph PCT17, wherein the conduit comprises a dual chamber conduit having a first chamber for pumping the monomer downhole and a second chamber for pumping the catalyst downhole.

PCT20. A method of forming solid polymeric proppants at the surface of a formation for use in a fracturing operation within the formation, comprising the steps of: combining reagents in a first mixing chamber; atomizing the combined reagents by passing them through an atomizer as they exit the first mixing chamber to form partially polymerized polymeric bodies; mixing the partially polymerized polymeric bodies and water in a second mixing chamber; completing polymerization and forming solid polymeric proppants upon exiting the second mixing chamber; pumping the solid polymeric proppants and water down a casing; and passing the solid polymeric proppants through perforations in the casing and into fractures formed within the formation.

### INDUSTRIAL APPLICABILITY

The systems and methods disclosed herein are applicable to the oil and gas industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

We claim:

1. A method of forming polymeric proppants in-situ during a fracturing operation within a formation, comprising the steps of:
delivering reagents downhole and combining the reagents in a first mixing chamber to initiate polymerization;
atomizing the combined reagents by passing them through an atomizer as they exit the first mixing chamber to form partially polymerized polymeric bodies;
pumping water down a production casing;
mixing the partially polymerized polymeric bodies and the water in a second mixing chamber;
completing polymerization and forming solid polymeric proppants upon exiting the second mixing chamber; and
passing the solid polymeric proppants through perforations in the casing and into fractures within the formation.

2. The method of claim 1, wherein the reagents comprise a monomer and a catalyst.

3. The method of claim 2, wherein the monomer comprises dicyclopentadiene and functionalized norbornene.

4. The method of claim 3, wherein the catalyst is a Grubbs catalyst.

5. The method of claim 4, wherein the combined reagents undergo rapid cross-linking polymerization to form the solid polymeric proppants.

6. The method of claim 1, wherein the solid polymeric proppants have a compressive strength of greater than 15 ksi.

7. The method of claim 1, wherein the solid polymeric proppants are hydrophobic.

8. The method of claim 1, wherein the solid polymeric proppants are formed as substantially spherical beads.

9. The method of claim 1, wherein the reagents are delivered downhole through a conduit positioned within the production casing.

10. The method of claim 9, wherein the conduit comprises a coiled tubing.

11. The method of claim 9, wherein the conduit comprises a dual chamber conduit to having a first chamber for pumping the monomer downhole and a second chamber for pumping the catalyst downhole.

12. The method of claim 9, wherein the conduit is coiled tubing sub that contains the reagents in predetermined amounts for mixing downhole to initiate polymerization.

13. The method of claim 1, wherein the ratio of monomer to catalyst is greater than about 25:1.

14. The method of claim 13, wherein the ratio of monomer to catalyst is about 50:1.

15. A system for forming polymeric proppants for use during a fracturing operation within a formation, the system comprising:
a first mixing chamber having a downstream end, for combining the reagents to initiate polymerization;
an atomizer positioned adjacent the downstream end of the first mixing chamber for forming partially polymerized polymeric bodies; and
a second mixing chamber positioned downstream of the atomizer for mixing the partially polymerized polymeric bodies and water pumped down the production casing to complete polymerization and form solid polymeric proppants.

16. A method of forming solid polymeric proppants at the surface of a formation for use in a fracturing operation within the formation, comprising the steps of:
combining reagents in a first mixing chamber;
atomizing the combined reagents by passing them through an atomizer as they exit the first mixing chamber to form partially polymerized polymeric bodies;
mixing the partially polymerized polymeric bodies and water in a second mixing chamber;
completing polymerization and forming solid polymeric proppants upon exiting the second mixing chamber;
pumping the solid polymeric proppants and water down a casing; and
passing the solid polymeric proppants through perforations in the casing and into fractures formed within the formation.

17. The method of claim 16, wherein the reagents comprise a monomer and a catalyst.

18. The method of claim 17, wherein the monomer comprises dicyclopentadiene and functionalized norbornene.

19. The method of claim 18, wherein the catalyst is a Grubbs catalyst.

20. The method of claim 16, wherein the combined reagents undergo rapid cross-linking polymerization to form the solid polymeric proppants.
